(19) United States
(12) Patent Application Publication
(10) Pub. No.: US 2022/0276609 A1
(43) Pub. Date: Sep. 1, 2022

(54) CAM-TYPE TIMEPIECE COMPONENT

(71) Applicant: ROLEX SA, Geneva (CH)

(72) Inventors: Florent Bruckert, Sciez-sur-Léman (FR); Florian Calame, Epalinges (CH); Alexandre Oliveira, Amancy (FR)

(73) Assignee: ROLEX SA, Geneva (CH)

(21) Appl. No.: 17/629,762

(22) PCT Filed: Apr. 10, 2020
(86) PCT No.: PCT/EP2020/060318

§ 371 Date: Jan. 24, 2022

(30) Foreign Application Priority Data
Apr. 15, 2019 (EP) 19169228.4

(51) Int. Cl. G04B 13/02; G04D 3/00; B23K 26/38

(52) U.S. Cl. CPC G04B 13/02; G04D 3/0017; G04D 3/0069; B23K 26/38

(57) ABSTRACT

A cam-type timepiece component (1), which has at least one portion of substantially planar shape, having a material hardness greater than or equal to 600 hv, this portion having a thickness greater than or equal to 350 microns, or even greater than or equal to 400 microns, and comprising at least one functional flank (3) which is substantially perpendicular to a main surface (2) of this portion and has a roughness ra of less than or equal to 50 nm.

### INTRODUCTION

The present invention relates to a cam-type horological component. The invention relates also to a horological movement and a timepiece, such as a watch, comprising such a horological component. It relates also to a method for manufacturing such a horological component.

### STATE OF THE ART

A cam-type horological component has the peculiar feature of having a lateral surface, called flank, defined to fulfil a functionality within a horological movement, by cooperating with a neighboring component. Such a lateral surface can also be called “functional flank”. To best fulfil their functionality, such horological components must ideally have a rigid flank, with low roughness and of perfectly defined orientation, generally in a plane perpendicular to a main surface of the horological component. These horological components may also have to have a significant thickness, to have a flank of sufficient surface area, which can prove difficult to coordinate with the functionality criteria set out above.

In addition to these specific properties of a functional flank, such a horological component must advantageously have the other properties generally expected of a horological component, such as an insensitivity to magnetic fields, and the possibility of being manufactured reliably and by mass production. Existing methods rely on machining steps that are more or less complex to obtain an acceptable functional flank. These methods are tedious, and often incompatible with a high rate, even unsuited to certain geometries or to certain materials.

The combination of all the constraints mentioned previously on a cam-type horological component, or to put it another way, one with a functional flank, means that the existing solutions are not totally satisfactory and that they rely on certain trade-offs which are not totally optimized.

Thus, one general aim of the invention is to define an improved solution for a horological component of cam type or with functional flank.

More particularly, one object of the invention is to offer a cam-type horological component solution that makes it possible to optimize the trade-off consisting in proposing industrial manufacture while achieving the most efficient possible functional flank.

### BRIEF DESCRIPTION OF THE INVENTION

To this end, the invention is based on a horological component, characterized in that it comprises at least one part of substantially flat form made of a material with a hardness greater than or equal to 600 HV, said part having a thickness greater than or equal to 350 microns, even greater than or equal to 400 microns, and comprising at least one functional flank substantially perpendicular to a main surface of said part and with a roughness Ra less than or equal to 50 nm.

The invention relates also to a method for manufacturing such a horological component, characterized in that it comprises a step of laser-cutting of a thick strip of material with a hardness greater than or equal to 600 HV, by the combination of two different laser beams within a liquid jet or by a femtosecond laser cutting, to form at least one functional flank of the horological component, said horological component having a thickness greater than or equal to 350 microns, even greater than or equal to 400 microns and in that it comprises a termination step.

The horological component therefore comprises at least one functional flank, such as a cam, a wheel, a spring, etc.

The invention is more specifically defined by the claims.

### BRIEF DESCRIPTION OF THE FIGURES

These aims, features and advantages of the invention will be explained in detail in the following description of particular embodiments given as nonlimiting examples in relation to the attached figures in which:

FIG. 1 represents a device for manufacturing a cam-type horological component according to an embodiment of the invention.

FIG. 2 is an enlargement of a part of the preceding figure.

FIGS. 3 and 4 represent perspective views from different angles of a cam-type horological component according to an embodiment of the invention.

The invention relies on a manufacturing method which comprises a first step of provision of a wafer 5 having a chosen significant thickness and made of the chosen material. As a variant, the wafer could be replaced by any other form, more generally termed “thick strip”. The material of this thick strip is chosen to be very rigid, notably with a hardness greater than or equal to 600 HV.

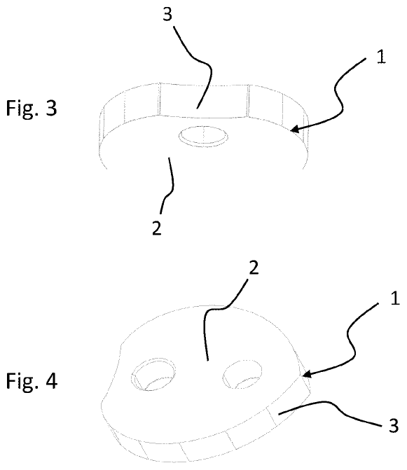

A method for manufacturing a cam for a horological movement will now be described according to an embodiment of the invention, more particularly represented by FIGS. 3 and 4. This embodiment could be extended to the manufacture of any metal horological component of cam type, or any metal horological component comprising at least one functional flank.

According to this first embodiment of the invention, the cam is designed in a very rigid metal material, notably with a hardness greater than or equal to 600 HV, and has a significant thickness, greater than or equal to 350 microns, even greater than or equal to 400 microns.

According to the first embodiment, the material is a metal alloy based on chrome, and/or on cobalt, and/or on copper, and/or on nickel. This alloy can for example be chosen from among the materials known by their tradenames Phynox®, Phytime®, Pfinodal®, or Nivaflex®, more generally from among the cobalt-based austenitic super alloys, the maraging steels, and the multiphase cobalt alloys. This alloy can also be chosen from among the amorphous alloys such as CoSO, Vitreloys and Metglas, more generally from among the amorphous alloys available in thicknesses greater than 350 microns. Advantageously, an alloy that is insensitive to magnetism is chosen.

This first embodiment involves a single-pass cutting which cuts all of the thickness in a single pass of the laser beam, as will be described hereinbelow, or a multi-pass cutting which requires several passes of the laser beam at the same point to cut all of the thickness, as will be detailed hereinbelow.

According to a second embodiment, the material is a ceramic or a cermet. As an example, this material can be chosen from among the cermets based on silver, or based on copper, or the cermets known by their GO312Wrose and Kyocera designation. This material can also be Al2O3 alumina or zirconia. It is likewise very rigid, notably with a hardness greater than or equal to 600 HV.

This second embodiment involves a multi-pass cutting, which necessitates several passes of the laser beam at the same point to cut all of the thickness, as will be detailed hereinbelow.

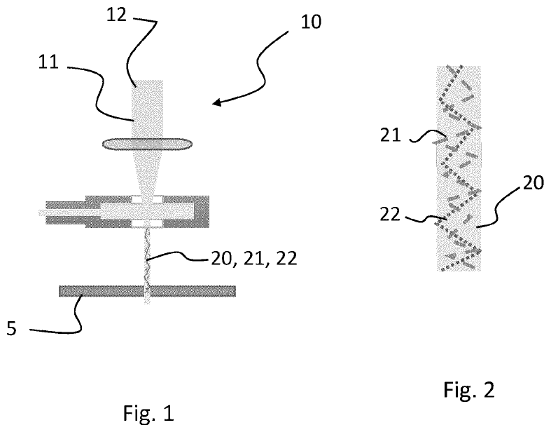

According to both embodiments of the invention, the manufacturing method then comprises a second step consisting in the cutting of the thick strip. FIG. 1 more specifically represents a manufacturing device 10 which implements this second step according to a first variant. This cutting step uses two laser beams of different and complementary natures. According to the first variant of the embodiments, the method uses a first laser source 11, called MASTER, that is to say a green laser with an average power at mid-height that can reach 50 W, with a pulse duration of between 80 and 400 ns and a frequency of 6 to 20 kHz, and a second laser source 12, called SLAVE, more specifically a green laser with an average power at mid-height that can reach 20 W with a pulse duration of between 7 and 20 ns and a frequency of 80 to 130 kHz. These two laser sources 11, 12 can be used simultaneously, as illustrated in FIGS. 1 and 2, or successively. In addition, according to the embodiments, these two laser sources respectively generate a beam 21, 22 which is guided within a liquid jet 20, as represented on the enlargement of FIG. 2. Such guidance is notably detailed in the document EP1750894. Depending on the type of material and its thickness, the cutting mode will be done in a single pass or multiple passes, as mentioned previously, independently of the simultaneous or successive use of the two laser sources 11 and 12.

Depending on the type of material and its thickness, the average powers at mid-height of the laser sources will be able to be lowered, for example to values of between 10 and 12 W for the MASTER laser source or to values of between 2 and 19 W for the SLAVE laser source. More particularly, for strips made of Phynox® with a thickness of 480 microns, the average power at mid-height of the SLAVE laser source can be between 2 and 5 W, even down to as low as 2 W. As a variant, other combinations of two laser sources can be implemented.

Alternatively, according to a second variant of the embodiments of the invention, the manufacturing method comprises a second step consisting in the cutting of the thick strip using a green femtosecond laser with an average power that can reach 55 W, with pulse times/durations of between 270 fs and 10 ps and a frequency ranging from 1 kHz to 2000 MHz. More particularly, for strips made of Phynox® with a thickness of 480 microns, the laser advantageously operates at 515 nm, at a frequency of 100 kHz, with an average power of 3 W. As a variant, other laser sources with ultra-short pulses, such as sources emitting in the infrared (1030 nm) or the ultraviolet (343 nm), can be used.

Finally, the manufacturing method advantageously comprises a termination step, which comprises all or part of the following additional steps:
a polishing of the main surface of the cam so as to reduce the roughness and guarantee the final thickness; and/or
a tribofinishing of the functional flank or flanks so as to reduce the roughness.

In addition, the manufacturing method can comprise a cleaning step and/or a heat treatment step.

FIGS. 3 and 4 illustrate a cam 1 of a horological movement in heart-shaped form according to an embodiment of the invention. It was obtained by the manufacturing method described above, and is made of Phynox® material with a thickness of 440 microns. It was obtained from a thick strip 480 microns thick, and underwent a finishing stage of polishing of its flat main surface 2, which reduced its thickness. The cam 1 also has functional flanks 3 perpendicular to its main surface 2 according to the definition below. Furthermore, after a termination step, notably after a polishing or tribofinishing step, the functional flanks 3 of the terminated cam have a roughness Ra less than 50 nm.

More generally, it appears that the invention relies on a new optimum in which a cam-type horological component simultaneously has a great hardness greater than or equal to 600 HV, a significant thickness, greater than or equal to 350 microns, even greater than or equal to 400 microns, even greater than or equal to 430 microns, a functional flank of controlled orientation, deviating at most by one degree relative to the desired orientation, and of very low roughness Ra, less than or equal to 50 nm. Notably, the functional flank has an angle greater than 89 degrees with respect to the plane of the adjacent main surface. It has an angle of between 89 and 90 degrees or between 89 and 91 degrees with respect to this plane. The roughness Ra can even be less than or equal to 40 nm, even less than or equal to 30 nm. The combination of these features is optimal; the invention in fact makes it possible to achieve an ideal result on each parameter, without prioritizing some to the detriment of others, which is noteworthy. In the case of a ceramic or cermet material, the same compromise is reached.

The horological component according to the invention can be any component that therefore has at least one functional flank. Advantageously, this horological component has a substantially two-dimensional form, comprising one or more functional flanks arranged on its outline between two opposing flat main surfaces. Its thickness is therefore measured as the distance between these two opposing main surfaces. As a variant, this concept can be extended to a more complex horological component, comprising at least one part corresponding to an embodiment of the invention. Also as a variant, the invention applies also to a component which could have a structure closer to a three-dimensional form, its main surfaces not for example being flat, but substantially flat. The thickness considered will then be the average thickness at the ends of the main surfaces, adjacent to the functional flank considered. The invention applies thus to at least one part of substantially flat form of a horological component, this part being defined by two substantially flat and parallel surfaces, called main surfaces, linked by a narrower surface therefore extending thicknesswise in said part, forming a flank of the horological component. This part of the horological component is advantageously made of a single material, in a single piece.

As an example, the horological component can be a cam, such as a heart-shaped, a spiral or notched cam snail, a shuttle or a column-wheel. It can be a date disk. It can comprise one or more functional flanks arranged on its perimeter. It can operate by performing a complete or an incomplete rotation, for example by performing back-and-forth movements. Naturally, the invention is not limited to the examples above.

Finally, the invention relates also to a horological movement incorporating at least one such horological component with functional flank. It relates also to a timepiece incorporating at least one such horological component with functional flank.

1. A method for manufacturing a cam-type horological component, wherein the method comprises:
cutting of a thick strip of material with a hardness greater than or equal to 600 HV, by the combination of two different laser beams within a liquid jet or by one laser beam of a femtosecond laser to form at least one functional flank of the horological component,
the horological component having a thickness greater than or equal to 350 microns, and
performing a termination action.

2. The method for manufacturing a cam-type horological component as claimed in claim 1, wherein the cutting comprises using the two different laser beams within the liquid jet, originating respectively from a first, MASTER laser source and from a second, different, SLAVE laser source to obtain the at least two different laser beams, alternating or in succession.

3. The method for manufacturing a cam-type horological component as claimed in claim 2, wherein the first, MASTER laser source is a green laser with an average power at mid-height less than or equal to 50 W with a pulse duration in a range of from 80 to 400 ns and a frequency in a range of from 6 to 20 kHz, and the second, SLAVE laser source is a green laser with an average power at mid-height less than or equal to 20 W with a pulse duration in a range of from 7 to 20 ns and a frequency in a range of from 80 to 130 kHz.

4. The method for manufacturing a cam-type horological component as claimed in claim 2, wherein
the cutting comprises the using the two different laser beams within the liquid jet in a single-pass cutting of a thick strip, a material of which is a metal alloy, or
the cutting is a multi-pass cutting of a thick strip, a material of which is a ceramic or a cermet.

5. The method for manufacturing a cam-type horological component as claimed in claim 1, wherein the cutting comprises using a femtosecond laser in a multi-pass cutting of a thick strip, a material of which is a metal alloy or a ceramic or a cermet.

6. The method for manufacturing a cam-type horological component as claimed in one claim 1, wherein the termination action comprises all or part of the following actions:
polishing the main surface of a cam of the component; and/or
tribofinishing of a functional flank or flanks of the component so as to reduce a roughness;
making it possible to reduce the roughness of the flank or flanks to a value less than or equal to 50 nm.

7. The method for manufacturing a cam-type horological component as claimed in claim 1, additionally comprising heat treating the component.

8. A cam-type horological component comprising:
at least one part of substantially flat form made of a material having a hardness greater than or equal to 600 HV,
the part having a thickness greater than or equal to 350 microns, and comprising at least one functional flank substantially perpendicular to a main surface of the part and having a roughness Ra less than or equal to 50 nm.

9. The cam-type horological component as claimed in claim 8, wherein the material is selected from the group consisting of metal based alloys based on Cr, Co, Cu, and/or cobalt-based austenitic super alloys, maraging steels, and multiphase cobalt alloys, and amorphous alloys of thicknesses greater than or equal to 350 microns.

10. The cam-type horological component as claimed in claim 8, wherein the thickness is greater than or equal to 430 microns.

11. The cam-type horological component as claimed in claim 8, wherein the component has a flat main surface and the at least one substantially perpendicular functional flank extends from the flat main surface and has an angle in a range of from 89 to 91 degrees inclusive with respect to the flat main surface.

12. The cam-type horological component as claimed in claim 8, wherein the at least one functional flank has a roughness Ra less than or equal to 40 nm.

13. The cam-type horological component as claimed in claim 8, wherein the cam-type horological component is a cam, a spiral or notched cam snail, a shuttle or a column-wheel.

14. A horological movement comprising a horological component as claimed in claim 8.

15. A timepiece comprising a horological movement as claimed in claim 14.

16. The method as claimed in claim 1, wherein the thickness is greater than or equal to 400 microns.

17. The cam-type horological component as claimed in claim 8, wherein the thickness is greater than or equal to 400 microns.

18. The cam-type horological component as claimed in claim 9, wherein the material is a multiphase cobalt alloy selected from the alloys those known by the tradenames Phynox®, Phytime®, Nivaflex®, and Pfinodal®.

19. The cam-type horological component as claimed in claim 9, wherein the material is an amorphous alloy of thickness greater than or equal to 350 microns selected from the group consisting of Co50, Vitreloys, and Metglas.

20. The cam-type horological component as claimed in claim 12, wherein the at least one functional flank has a roughness Ra less than or equal to 30 nm.
